(19) United States
(12) Patent Application Publication
(10) Pub. No.: US 2022/0061227 A1
(43) Pub. Date: Mar. 3, 2022

(54) Devices for an optimized, high-intensity, horticultural, led luminaire having a regulated photosynthetic flux density

(71) Applicant: Growor, Inc., Lewes, DE (US)

(72) Inventor: Michael Naich, Rishon LeZion (IL)

(73) Assignee: Growor, Inc., Lewes, DE (US)

(21) Appl. No.: 17/423,735

(22) PCT Filed: Jan. 21, 2019
(86) PCT No.: PCT/US2019/014411

§ 371 Date: Jul. 16, 2021

(51) Int. Cl. A01G 7/04; H05B 45/20; F21V 29/70

(52) U.S. Cl. CPC A01G 7/045; F21Y 2115/10; F21V 29/70; H05B 45/20

(57) ABSTRACT

The present invention discloses devices for enhancing regulated plant growth in vegetative and flowering modes. Luminaires include: at least one LED cluster, for providing enhanced regulated plant growth by simulating dynamic natural daylight conditions, each LED cluster having a cluster surface-area dimension less than 0.40 dm², and each LED cluster including: blue modules having a plurality of blue absorption-band diodes configured to produce a Photosynthetic Photon Flux Density (PPFD) of at least 120 micromoles per square meter per second (≥120 μmol/m²); and red modules having a plurality of red absorption-band diodes configured to produce a PPFD of at least 150 micromoles per square meter per second (≥150 μmol/m²); and at least one hemispherical lens for enabling even distribution of output spectral intensities and output spectral wavelengths from the blue and red modules over a designated, target plant bed, each hemispherical lens disposed to fully enclose each LED cluster.

### FIELD AND BACKGROUND OF THE INVENTION

The present invention relates to devices for an optimized, high-intensity, horticultural, LED luminaire having a regulated Photosynthetic Photon Flux Density (PPFD). In particular, the present invention relates to the field of agriculture, plant growth methodology, and plant development regulation via controlled lighting conditions and regimens.

Ecological issues related to growth methodology and equipment have come to the forefront in plant production. Various types of chemicals are used to control plant growth (e.g., fertilizers and retardants). The use of optical radiation having a specific spectral composition is an alternative to implementing artificial light sources.

The three main parameters associated with light radiation which affect plant growth are as follows.
1. Intensity—affects the photosynthesis process during which the chemical processes related to conversion of CO2 into carbohydrates take place. The main indicator in crop production, which determines the intensity, is a flux density of Photosynthetically Active Radiation (PAR), measured in μmol/m²s. The PPFD is a measurement that determines the total amount of PAR a light source produces. PAR defines the type of light needed to support photosynthesis, while PPFD determines the amount of PAR that is created by a lighting system each second.
2. Photoperiod—represents the amount of time that plants are exposed to light, affecting when the plants begin their flowering/reproductive process. Using various lighting conditions and regimens to simulate “day” and “night” for different types of crops, one can achieve significant improvement in growth results.
3. Spectrum—influences growth, formation, development, and crop flowering due to the fact that different wavelengths have different effects on plants. For example, the wavelengths of 200-380 nm are mostly harmful to growth, or at a minimum useless. Another example is the spectral range above 1000 nm, which is converted into heat, and does not affect plant growth.

By definition, photosynthesis is activated in the PAR range of 380-720 nm, as well as the photoregulation of all biochemical processes in plants. Plants have photoreceptor systems which provide energy absorption throughout the entire PAR. The absence of spectral regions in the radiation source can lead to a disruption of normal plant growth during cultivation.

Optimizing the spectral characteristics of a light source can result in a substantial enhancement in yield. Such optimization relates to both lighting conditions and regimens. This means: (1) determining the required spectral bands in the radiation composition, (2) optimizing the radiation intensity, (3) designating the duration of light exposure, and (4) defining the necessary correlations between the previous three parameters.

In this regard, efforts of plant-growth developers are aimed at creating energy-efficient irradiation facilities for greenhouses, allowing plants to be illuminated with only a requisite and periodic amount of quality radiation (i.e., spectral quality).

Photosynthesis, an energy-intensive process provided by chlorophylls (i.e., Chlorophylls A-F) and carotenoids, consists of two phases: a “light phase” (or light-dependent stage) occurring exclusively when light is present, and a “dark phase” (or light-independent stage) for which carbon dioxide is a necessary component. Chlorophylls, which absorb the light of the red and blue bands, exclusively participate in solar-energy transformation. Carotenoids are a group of pigments that absorb light in the spectral region of 400-550 nm and play an auxiliary role. The main function of carotenoids is the absorption of energy and its transfer to chlorophyll.

Of all the photo-processes in plants, photosynthesis is the most energy-intensive. For example, required irradiation levels are 1-3 orders of magnitude greater for photosynthesis than for photomorphogenesis with a requisite photoperiodism for its PPFD. The efficiency of the main photochemical processes depends on the wavelength of the incident radiation on the plant. Such dependence is due to the fact that each pigment has its own specific absorption spectrum.

Photomorphogenesis is a change in plant size and shape under the influence of various spectral regions and intensity of radiation. Photomorphogenesis plays a regulatory role in plant development and growth by switching basic regulatory mechanisms as a response to plant exposure to adequate lighting conditions. A photoregulatory system includes light receptors and light-signal transducers in which the photoreceptors convert photons into biochemical signals.

The main sensory pigments having photoregulatory properties are: phytochromes, cryptochromes, phototropins, and superchromes or neochromes (i.e., chimeric photoreceptor genes). Upon exposure, phytochromes absorb red and far-red light, cryptochromes and phototropins absorb near ultraviolet and blue light, and superchromes/neochromes absorb red and blue light.

A photoregulatory effect triggered by red light is mainly due to phytochrome. Phytochrome exists in two forms with different properties. Under the influence of red light (660 nm) or far-red light (730 nm), these two forms transform into each other. This response behavior is similar to the behavior of a switch (i.e., with the result of the last exposure is always preserved).

A plant's flowering activity is also controlled by phytochrome (690-780 nm). Phytochrome provides a tracking of daylight time (i.e., morning to evening), thus in effect controlling a photoperiodicity of a plant's activity. Based on signaling of the phytochrome system, a plant changes its growth strategy. The plant may prepare for photosynthesis, spend all its energy on growth, begin to blossom, defoliate, germinate seeds, or wait for better lighting conditions.

Another photosensitive system in plants is associated with the blue region of the spectrum. Photoreceptors of blue light are cryptochromes and phototropins. The absorption spectrum of cryptochrome is in the range of 400-500 nm. For adult plants, the blue range regulates the width of leaf stomata, controls the movement of leaves to track the sun, and inhibits the growth of stems.

Blue light also controls phototropism (i.e., the bending of sprouts and stems in the sun's direction). Pigments with absorption maxima in the blue region are responsible for an increase in biomass (i.e., dry mass gain). The highest photosynthesis rate per unit leaf area is observed when it is irradiated with blue light. In the absence of blue light (e.g., in dense plantings or under glass), plants are stretched. Some suggest that blue light has a different effect on plants at different times of the day.

Photoperiodism is a process governed by the duration of daylight—the most important photoregulatory factor. Photoperiodism controls the processes of plant transitioning to flowering as well as growth processes. Such activity is associated with an excitation of certain pigments (i.e., photoreceptors). The physiological response to a change in daylight duration is a photoperiodic reaction of the plant.

It is generally held that a full absorption spectrum mimicking sunlight is ideal for plant growth. The website of a lighting-system supplier (Hortilux) lists the “3 Keys to Successful Indoor Plant Growth” with the following assertion with regard to spectrum. “As light intensity increases, the light spectrum becomes more important. Natural sunlight is intense and has a broad and balanced spectrum. Indoor plants require the same high intensity and broad but balanced spectrum.” As discussed below in the Summary section, such lighting strategies are far from optimal, if not indeed deleterious.

In the prior art, EP Application No. 2056364 A1 by Satou et al. (Mitsubishi Chemical Corp.) and US Patent Publication No. 2009/0231832 by Zukauskas et al. (Sensor Electronic Technology Inc.) disclose the ability to increase the number of colors generated by LEDs by using materials such as luminophores which convert wavelengths to reradiate different colors. Such lamps have many disadvantages. For lighting greenhouses, the spectrum of sunlight is only partially optimal for plant growth.

Klase et al., US Patent Publication No. 2012/0218750, discloses systems and methods for promoting plant growth that combine beam angle control with spectral control. In one embodiment, an optical device can be configured to emit multiple colors of light at particular wavelengths. The optical device may also be configured to generate an emission spectrum with multiple peaks. The spectrum can be selected based on stimulating biological processes of a plant.

Dubuc et al., US Patent Publication No. 2012/0161170, discloses a light emitting device for producing radiation optimal for plant growth is provided. The light emitting device comprises at least one LED chip having a peak wavelength disposed on a Support, a phosphor material radiationally coupled to the at least one LED chip. The phosphor materials are capable of absorbing at least a portion of the radiation from the at least one LED chip and emitting light of a second wavelength. The light emitting device further includes an optical element at least partially covering the at least one LED chip and Support. The light emitting device is capable of uniformly mixing the red and blue radiation to produce pink radiation.

Karpinski et al., US Patent Publication No. 2013/0255150, discloses a method of improving the growth and/or pathogen resistance of a plant, comprising the step of exposing at least part of the plant to a transient period of high intensity illumination providing a photon flux at the plant surface having at least one of the following characteristics: (a) a red photon flux comprising at least 100 micromoles photons per square metre per second, and having a wavelength of between 600 and 700 nm, (b) a blue photon flux comprising at least 100 micromoles photons per square metre per second, having a wavelength of between 420 and 480 nm. The Invention also provides apparatus for providing such conditions to growing plants.

Nanoco Technologies Ltd. et al., US Patent Publication No. 2013/032694, discloses Quantum dot (QD) LEDs useful for plant, algael and photo synthetic bacterial growth applications. The QD LEDs utilizes a solid state LED (typically emitting blue or UV light) as the primary light source and one or more QD elements as a secondary light source that down-converts the primary light. The emission profile of the QD LED can be tuned to correspond to the absorbance spectrum of one or more photosynthetic pigments of the organism.

Osram Sylvania Inc., WO 2016/138319A1, disclose an active damping circuit and system. The active damping circuit includes a first resistor, a second resistor, a third resistor, a first transistor, a second transistor, a capacitor, and a microcontroller. The first resistor is connected to a base of the first transistor, and to the microcontroller output. The second resistor is connected to a positive voltage, and to a collector of the first transistor and a gate of the second transistor. The third resistor is connected to a logic ground, and to a source of the second transistor. The capacitor is connected to the collector of the first transistor, the second resistor, and the gate of the second transistor. A drain of the second transistor, and the first capacitor, and the second capacitor, and the microcontroller output, are also connected to the logic ground. An emitter of the first transistor is connected to ground.

The device by Zukauskas et al., which is aimed at reproducing sunlight artificially, produces many wavelengths that are not effectively used by plants as they grow (e.g., the 500-600 nm band (green light) is poorly used by plants, since green plants reflect these wavelengths, which is the source of exhibiting their green color). Such light sources lead to a substantial waste of energy in greenhouses. Moreover, existing lamps do not have important wavelengths useful for plant growth. For example, such devices do not reach the far-red spectral segment of 700-800 nm, which is important for crop growth.

A LED lamp is disclosed in Russian Federation Patent No. 2369086 having a set of LEDs of different emission spectra, with the LEDs mounted on the electrical boards, which are installed in a row of leak-tight, tube-shapes encasements. The encasements are installed inside the device body with gaps in several parallel rows so that the central axes of the LED light fluxes are directed in one direction to the front surface of the body, perpendicular to its surface. Such lamps limit the power supply to a low voltage and a low operating temperature of the device body.

While such a device is durable, splash proof, and does not interfere with radiation from other light sources, the drawbacks of this lighting configuration are significant. In particular, such devices require large dimensions for complete lighting of greenhouse beds, as well as cooling equipment for proper extended operation of the LEDs. The tube-shaped encasements are implemented for mitigating the cooling problem by drawing heat away from the LEDs via air circulation.

A popular commercial growth lamp is the Apollo 4 LED GrowLight (see www.growlight.cn/new-light.asp) for triggering plant growth by using a phyto-spectrum with peaks of 660 nm and 450 nm. The apparatus uses individually-isolated LEDs which are actively-cooled and special lenses for individually directing and focusing the light energy, with emission bands in the red at 660 nm and in the blue at 455 nm—no UV or IR wavelengths.

By implementing a lot of low-power LEDs separated from each other by a distance, the resulting lighting produced is uneven in spectral range and intensity. Such solutions suffer from being practically impossible to ensure uniform exposure (with regard to both spectrum and intensity), unable to regulate lighting direction, unable to provide vertical lighting, having large overall dimensions, and creating mounting issues due to its substantial weight.

The LED lamp Spectrum King SK 600 (www.spectrumkingled.com) is a universal light source providing a full absorption spectrum (similar to natural sunlight), and is used for various stages of plant growth. While the problems with a full spectral range have been mentioned (and will be discussed further), the Spectrum King apparatus asserts to regulate the various stages of growth and maturation by manually adjusting the height of the lamp from the plant bed, lacking any flexibility to efficiently automating or programming.

It would be desirable to have devices for an optimized, high-intensity, horticultural, LED luminaire having a regulated PPFD. Such devices would, inter alia, overcome the various limitations mentioned above.

### SUMMARY

It is the purpose of the present invention to provide devices for an optimized, high-intensity, horticultural, LED luminaire having a regulated PPFD.

It is noted that the term “exemplary” is used herein to refer to examples of embodiments and/or implementations, and is not meant to necessarily convey a more-desirable use-case. Similarly, the terms “alternative” and “alternatively” are used herein to refer to an example out of an assortment of contemplated embodiments and/or implementations, and is not meant to necessarily convey a more-desirable use-case. Therefore, it is understood from the above that “exemplary” and “alternative” may be applied herein to multiple embodiments and/or implementations. Various combinations of such alternative and/or exemplary embodiments are also contemplated herein.

Embodiments of the present invention provide optimized devices for an optimized, high-intensity, horticultural, LED luminaire having a regulated PPFD for greenhouses as well as home-plant lighting. More powerful luminaires are configured to industrial greenhouses for vegetable growing and flower crops that have insufficient, or are absent of, natural light.

Differences between the plant-growth effectiveness resulting from exposure to a full absorption spectrum and a selective-wavelength absorption spectrum are due to the fact that there are excited-state, energy-transfer processes between the molecules of selected pigments, causing perturbations in the electron transport chain (ETC) of the light-dependent reactions (i.e., photophosphorylation). The light-dependent reactions take place on the thylakoid membranes using four membrane-bound proteins: photosystem I (PSI), photosystem II (PSII), cytochrome (C), and ferredoxin NADP reductase (FNR). In these reactions, light energy is used to split water, oxygen is given off, hydrogen is produced, and ADP is phosphorylated to make ATP for each growth mode.

When excited molecules have nearby neighboring molecules, the excitation energy may be transferred through electromagnetic interactions from one molecule to another. Excited molecules can also relax by various competing pathways (e.g., resonance stabilization, solvation, and non-radiative relaxation via conversion to other excitation states). Using light energy, PSII acts first to channel an electron through a series of acceptors that drive a proton pump to generate ATP, before passing the electron on to PSI. Once the electron reaches PSI, most of its energy has been used to produce ATP, but a second photon of light captured by P700 provides the required energy to channel the electron to ferredoxin, generating reducing power in the form of NADPH.

It is well-known that light may be separated into a spectrum of different wavelengths: UV below 380 nm, violet at 380-430 nm, blue at 430-490 nm, green at 490-570 nm, yellow at 570-600 nm, red and far-red at 600-780 nm, and infrared above 780 nm. Each region of the spectrum has its own impact on plant physiology. The UV region below 280 nm is destructive for plants. The range of 315-380 nm is responsible for metabolism and plant growth. UV radiation in this range prevents stems from elongating. Radiation at 280-315 nm increases the cold resistance of plants.

Blue (430-490 nm) and purple (380-430 nm) regions hinder extensive plant growth. Exposure to such radiation stimulates protein synthesis and cell division in plants. These regions of the spectrum are almost fully absorbed by chlorophyll, which is important for intensive photosynthesis. The green region of the spectrum (490-570 nm) is practically not absorbed by plant lamina; thus, green light in excess causes plants to thin and elongate (i.e., lose biomass). In such lighting conditions, photosynthesis proceeds, but at a slow pace. Peak activity of photosynthesis occurs upon exposure to red and far-red light regions in the range of 600-780 nm. This spectral region affects the development and regulation of all processes: metabolism, respiration, root-system development, and flowering. The range of 625-720 nm is the most important segment, which is responsible for growth and production of carbohydrates due to dense absorption by chlorophyll. The IR region also affects plants, but more specifically by creating appropriate thermal conditions for physiological processes and photosynthesis.

Embodiments of the present invention enable a regulated PPFD, corresponding to the spectral bands of PAR, having an intensity of 10-30 W/m², resulting in a maximum photosynthesis rate in green leaf plants. Green leaves absorb radiation in the range of 625-720 nm, corresponding to the red region, with another absorption peak corresponding to the blue range of 440-460 nm. Such a selective-wavelength absorption spectrum is highly suitable for implementing in supplementary lighting in greenhouses (“phyto-lighting”), particularly LED lighting as an energy-efficient light source, with low electric-power consumption and high durability.

Moreover, there are other peaks near the UV region (300-400 nm) and in the far-red segment of the spectrum (700-800 nm). A portion of the spectrum in the far-red region is used by plants in the bioprocesses of photomorphogenesis, which results in change in shape (i.e., leaf unfolding, seed germination, and photoperiodic induction) in response to the spectral quality and quantity of lighting. Parts of the UV range are used by plants in the processes of organ orientation, stomata opening, germination, and root growth. A combination of red and blue LEDs is used in implementing embodiments of the present invention.

Therefore, according to the present invention, there is provided for the first time a luminaire for enhancing regulated plant growth in a vegetative mode, the luminaire including: (a) at least one vegetative Light-Emitting Diode (LED) cluster for providing enhanced regulated plant growth by simulating dynamic natural daylight conditions, wherein each vegetative LED cluster has a cluster surface-area dimension of less than about 0.40 dm², and wherein each vegetative LED cluster including: (i) a Blue Vegetative Module (VM) having a plurality of blue absorption-band diodes configured to produce a Photosynthetic Photon Flux Density (PPFD) of at least 150 micromoles per square meter per second (≥150 μmol/m²s); and (ii) a Red VM having a plurality of red absorption-band diodes configured to produce a PPFD of at least 200 micromoles per square meter per second (≥200 μmol/m²s); and (b) at least one hemispherical lens for enabling even distribution of output spectral intensities and output spectral wavelengths from the Blue VM and the Red VM over a designated, target plant bed, each hemispherical lens disposed to fully enclose the each vegetative LED cluster.

Alternatively, the cluster surface-area dimension is selected from the group consisting of: less than about 0.35 dm² and less than about 0.30 dm².

Alternatively, each vegetative LED cluster is adapted to provide the output spectral intensities and output spectral wavelengths having a spectral intensity deviation and a spectral uniformity deviation of less than about 10% each, as determined by measurement differences between the center of each vegetative LED cluster and an edge of each vegetative LED cluster.

Most alternatively, the spectral intensity deviation and the spectral uniformity deviation are less than about 5% each, as determined by measurement differences between the center of each vegetative LED cluster and an edge of each vegetative LED cluster.

Alternatively, each vegetative LED cluster is adapted to provide the output spectral intensities having a total light power of at least about 130 W and a total light power density of at least about 325 W/dm².

Most alternatively, the total light power density is selected from the group consisting of: at least about 370 W/dm² and at least about 430 W/dm².

Most alternatively, the total light power is at least about 135 W and the total light power density is selected from the group consisting of: at least about 385 W/dm², at least about 450 W/dm², and at least about 500 W/dm².

Alternatively, the Blue VM has LED output characteristics exhibiting a leader peak at 463 nm with a Full-Width at Half-Max (FWHM) of 15 nm, based on relative intensity; and wherein the Red VM has LED output characteristics exhibiting a leader peak at 656 nm with an FWHM of 10 nm, based on relative intensity.

Alternatively, the luminaire further includes: (c) at least one power source for independently regulating the Blue VM and the Red VM using damped, direct current (DC) inputs in order to prevent PPFD outputs from flickering or pulsing during operational changes in the output spectral intensities and/or the output spectral wavelengths.

Most alternatively, the further includes: (d) at least one switching/control unit for independently programmably regulating, using the damped, DC inputs, the Blue VM and the Red VM in order to independently maintain a desired intensity ratio of the output spectral intensities and a desired wavelength ratio of the output spectral wavelengths between the Blue VM and the Red VM.

Alternatively, the luminaire further includes: (c) at least one radiator for enabling dissipating heat generated by at least one vegetative LED cluster, wherein each radiator is adapted to maintain low thermal resistance with a respective vegetative LED cluster, and wherein each radiator is adapted to maintain a radiator temperature below about 45° C. during operation of the respective vegetative LED cluster.

According to the present invention, there is provided for the first time a luminaire for enhancing regulated plant growth in a flowering mode, the luminaire including: (a) at least one flowering Light-Emitting Diode (LED) cluster for providing enhanced regulated plant growth by simulating dynamic natural daylight conditions, wherein each flowering LED cluster has a cluster surface-area dimension of less than about 0.40 dm², and wherein each flowering LED cluster including: (i) a Deep-Blue Flowering Module (FM) having a plurality of blue absorption-band diodes configured to produce a Photosynthetic Photon Flux Density (PPFD) of at least 120 micromoles per square meter per second (≥120 μmol/m²s); and (ii) a Far-Red FM having a plurality of red absorption-band diodes configured to produce a PPFD of at least 150 micromoles per square meter per second (≥150 μmol/m²s); and (b) at least one hemispherical lens for enabling even distribution of output spectral intensities and output spectral wavelengths from the Deep-Blue FM and the Far-Red FM over a designated, target plant bed, each hemispherical lens disposed to fully enclose each flowering LED cluster.

Alternatively, the cluster surface-area dimension is selected from the group consisting of: less than about 0.35 dm² and less than about 0.30 dm².

Alternatively, each flowering LED cluster is adapted to provide the output spectral intensities and output spectral wavelengths having a spectral intensity deviation and a spectral uniformity deviation of less than about 10% each, as determined by measurement differences between the center of each flowering LED cluster and an edge of each flowering LED cluster.

Most alternatively, the spectral intensity deviation and the spectral uniformity deviation are less than about 5% each, as determined by measurement differences between the center of each flowering LED cluster and an edge of each flowering LED cluster.

Alternatively, each flowering LED cluster is adapted to provide the output spectral intensities having a total light power of at least about 130 W and a total light power density of at least about 325 W/dm².

Most alternatively, total light power density is selected from the group consisting of: at least about 370 W/dm² and at least about 430 W/dm².

Most alternatively, total light power is at least about 135 W and the total light power density is selected from the group consisting of: at least about 385 W/dm², at least about 450 W/dm², and at least about 500 W/dm².

Alternatively, the Deep-Blue FM has LED output characteristics exhibiting a leader peak at 425 nm with a Full-Width at Half-Max (FWHM) of 15 nm, based on relative intensity; and wherein the Far-Red FM has LED output characteristics exhibiting a leader peak at 728 nm with an FWHM of 10 nm, based on relative intensity.

Alternatively, the luminaire further includes: (c) at least one power source for independently regulating the Deep-Blue FM and the Far-Red FM using damped, direct current (DC) inputs in order to prevent PPFD outputs from flickering or pulsing during operational changes in the output spectral intensities and/or the spectral wavelengths.

Most alternatively, the luminaire further includes: (d) at least one switching/control unit for independently programmably regulating, using the damped, DC inputs, the Deep-Blue FM and the Far-Red FM in order to independently maintain a desired intensity ratio of the output spectral intensities and a desired wavelength ratio of the output spectral wavelengths between the Deep-Blue FM and the Far-Red FM.

Alternatively, the luminaire further includes: (c) at least one radiator for enabling dissipating heat generated by at least one flowering LED cluster, wherein each radiator is adapted to maintain low thermal resistance with a respective flowering LED cluster, and wherein each radiator is adapted to maintain a radiator temperature below about 45° C. during operation of the respective flowering LED cluster.

These and further embodiments will be apparent from the detailed description and examples that follow.

### BRIEF DESCRIPTION OF THE DRAWINGS

The present invention is herein described, by way of example only, with reference to the accompanying drawings, wherein:

FIG. 1 depicts a perspective view of an optimized, high-intensity, horticultural, LED luminaire having a regulated PPFD, according to embodiments of the present invention;

FIG. 2 depicts a top internal view of the LED luminaire of FIG. 1, according to embodiments of the present invention;

FIG. 3A depicts the original spectra of the light output of the LED luminaire of FIG. 1 exhibiting the regulated PPFD and the reference McCree action spectrum, according to embodiments of the present invention;

FIG. 3B depicts the absorption spectra of Chlorophyll A, Chlorophyll B, and Carotenoids aligned with the photosynthesis rate for the deep-blue and deep-red spectral bands of the LED luminaire of FIG. 1 exhibiting the regulated PPFD, according to embodiments of the present invention;

FIG. 4A depicts the original spectra of the Vega Red light output (vegetative mode) of the LED luminaire of FIG. 1 exhibiting the regulated PPFD and the reference Phytochrome Pr spectrum, according to embodiments of the present invention;

FIG. 4B depicts the weighted spectra of the Vega Red light output (vegetative mode) of the LED luminaire of FIG. 1 exhibiting the regulated PPFD and the reference Chlorophyll A spectrum, according to embodiments of the present invention;

FIG. 4C depicts the weighted spectra of the Vega Blue light output (vegetative mode) of the LED luminaire of FIG. 1 exhibiting the regulated PPFD and the reference Chlorophyll B spectrum, according to embodiments of the present invention;

FIG. 4D depicts the original spectra of the Flowering Far-Red light output (flowering mode) of the LED luminaire of FIG. 1 exhibiting the regulated PPFD and the reference Chlorophyll F spectrum, according to embodiments of the present invention;

FIG. 4E depicts the weighted spectra of the Flowering Far-Red light output (flowering mode) of the LED luminaire of FIG. 1 exhibiting the regulated PPFD and the reference Chlorophyll F spectrum, according to embodiments of the present invention;

FIG. 4F depicts the weighted spectra of the Flowering Deep-Blue light output (flowering mode) of the LED luminaire of FIG. 1 exhibiting the regulated PPFD and the reference β-Carotene spectrum, according to embodiments of the present invention.

### DESCRIPTION OF THE ILLUSTRATIVE EMBODIMENTS

The present invention relates devices for an optimized, high-intensity, horticultural, LED luminaire having a regulated PPFD. The principles and operation for providing such devices, according to the present invention, may be better understood with reference to the accompanying description and the drawings.

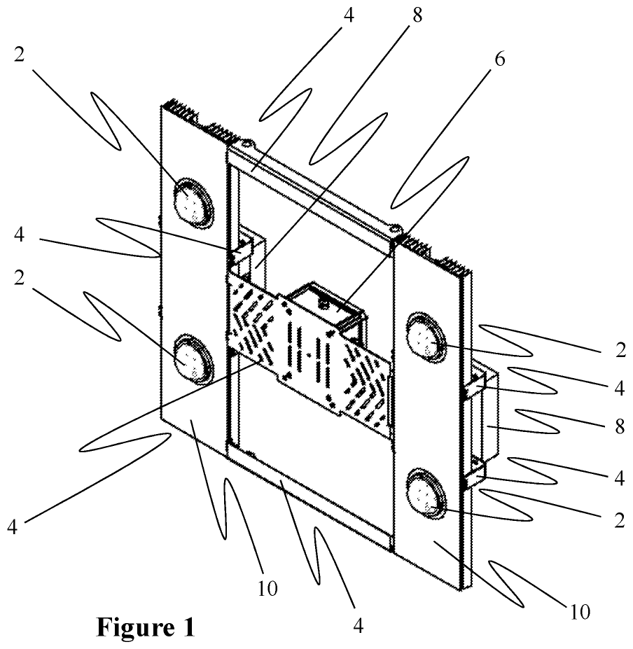

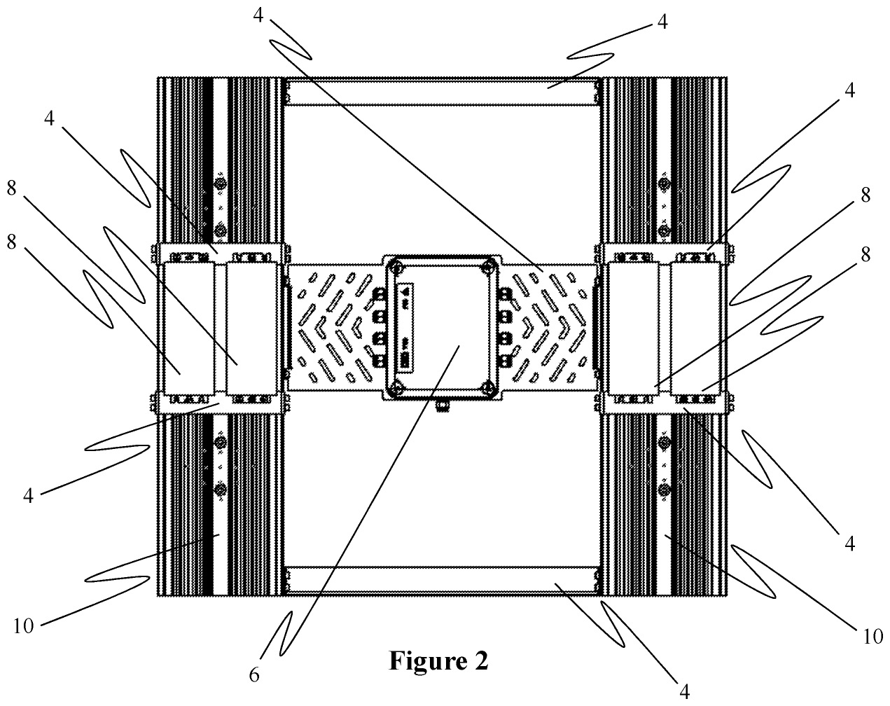

Referring to the drawings, FIG. 1 depicts a perspective view of an optimized, high-intensity, horticultural, LED luminaire having a regulated PPFD, according to embodiments of the present invention. The multifunctional, phyto-lighting LED luminaire is shown in FIG. 1 having four hemispherical lenses 2 enclosing dual-channel, high-power LED clusters (not shown) with supporting structural elements 4, a power supply 6 (having four damped current sources), switching/control units 8, and two radiators 10. FIG. 2 depicts a top internal view of the LED luminaire of FIG. 1, according to embodiments of the present invention.

The two pairs of LED clusters (four total) are configured to operate in two modes: a vegetative mode (“Vega”—meaning between germination and flowering during which plants perform photosynthesis and accumulate resources needed for flowering and reproduction) and a flowering mode (“Flowering”—meaning maturation and fruit growth in which plants produce their flower sets, vegetables, and fruits). A high packing density of red and blue spectral diodes is implemented in the LED clusters. Each Vega cluster contains 60 LEDs (35 red diodes and 25 blue diodes), and each Flowering cluster contains 61 LEDs (45 far-red diodes and 16 blue diodes). In the standard operating mode, the ratio of red and blue light emission is typically around 60% and 40% (optimally 62% and 38% in some cases), respectively.

It is noted that the surface-area dimension of a cluster represents the two-dimensional area obscured by the physical footprint of the cluster containing the LEDs. The surface-area dimension for such an LED cluster can be less than about 0.40 dm², less than about 0.35 dm², or less than about 0.30 dm². In the configuration tested below, the surface area of each cluster was 0.27 dm².

The red and blue emission spectra within a single cluster can be independently controlled. The distance between hemispherical lenses 2 on radiators 10 is calculated for even coverage of a plant-bed area of 1.2×1.2 m. Hemispherical lenses 2 are located 90 degrees from the center of the respective LED clusters, and provide full emission light exposure at 20 cm above the top leaves of plants, for example.

Each LED cluster is adapted to provide the output spectral intensities and output spectral wavelengths with a spectral intensity deviation and a spectral uniformity deviation of less than about 5-10% each, as determined by measurement differences between the center of each LED cluster and an edge of each LED cluster.

Combining the full spectra of different intensities and different photon flux energies allows for fully mimicking a sunny day by maintaining an even distribution of selected spectra throughout the exposure area of the plant bed. Switching among selected spectral bands may be performed by smoothly changing the lighting intensity and the intensity ratio of the first and second spectra.

The lighting intensity can be regulated by power supply 6 with a damped current of 0.7 A, 0.5 A, and 0.35 A. Control in direct-current (DC) modes allows the system to operate smoothly, avoiding pulsations or flickering effects, which is important for the sustainable plant development. The LED clusters in vegetative mode provide a minimum PPFD from the red absorption-band diodes of at least 200 micromoles per square meter per second (≥200 μmol/m²s), and a minimum PPFD from the blue absorption-band diodes of at least 150 micromoles per square meter per second (≥150 μmol/m²s). The LED clusters in flowering mode provide a minimum PPFD from the red absorption-band diodes of at least 150 micromoles per square meter per second (≥150 μmol/m²s), and a minimum PPFD from the blue absorption-band diodes of at least 120 micromoles per square meter per second (≥120 μmol/m²s).

Each LED cluster is adapted to provide the output spectral intensities having a total light power of at least about 130-135 Watts (W). In the configuration tested below, the total light power of each cluster was 137.5 W. Thus, total light power density can be at least about 325 W/dm². Depending on the total light power and surface area of the cluster, the total light power density can include a range of values such as: at least about 370 W/dm², at least about 385 W/dm², at least about 450 W/dm², and at least about 500 W/dm². In the configuration tested below, the total light power density of each cluster was 509.3 W/dm².

The control system using four switching/control units 8 (which independently control the blue, blue & UV, red, and far-red emission bands) allows for separate and simultaneous, synchronized control of horticultural luminaire systems, both over a single plant bed and a greenhouse having many plant beds as a whole.

Radiators 10 enable the efficient dissipation of heat generated by the LED clusters. Each radiator 10 is adapted to maintain a low thermal resistance by being in intimate thermal contact with its respective LED cluster. Each radiator 10 is adapted to maintain the radiator temperature below about 45° C. during operation. Typical cluster operating temperatures are in the range of about 30-45° C. Radiators 10 can include heatsinks made from various materials (e.g., extruded aluminum alloys) and specially-configured contact walls to adjust wall thickness and contact area with the cluster.

It is noted that the attributes such as cluster surface-area dimension, cluster control, spectral intensity deviation, spectral uniformity deviation, output spectral wavelengths, output spectral intensities, total light power, total light power density, intensity ratio, wavelength ratio, radiator heat dissipation. leader peak characteristics, peak linewidths, and/or flicker-less regulation and control can be combined in any combination within the LED luminaire of FIG. 1, and are considered fully-contemplated aspects of the present invention.

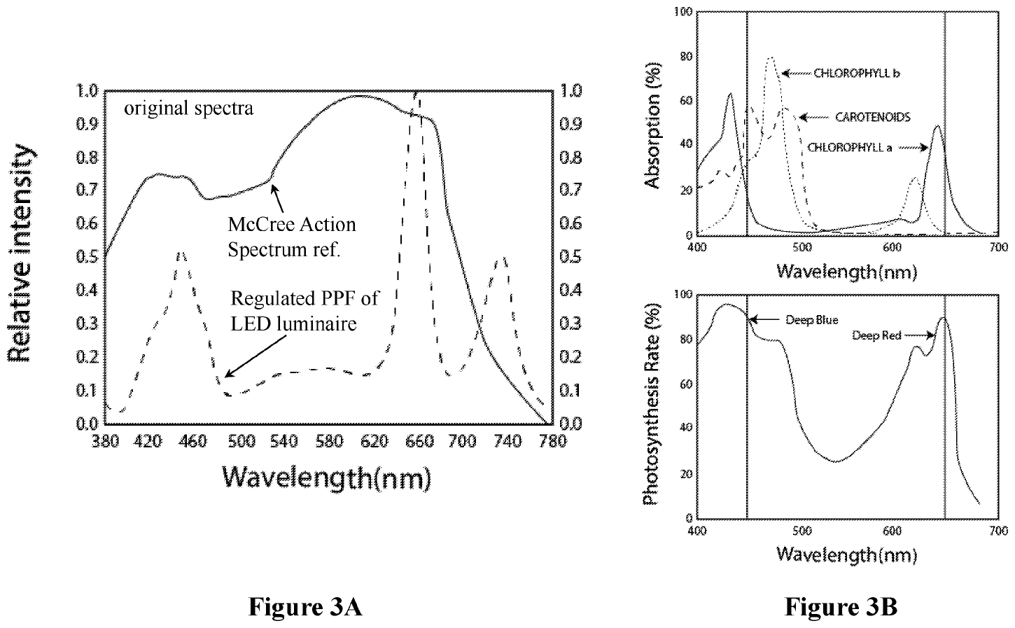

FIG. 3A depicts the original spectra of the full light output of the LED luminaire of FIG. 1 exhibiting the regulated PPFD and the reference McCree action spectrum, according to embodiments of the present invention. An action spectrum is the rate of a physiological activity plotted against wavelength of light. It shows which wavelength of light is most effectively used in a specific chemical reaction. Some reactants are able to use specific wavelengths of light more effectively to complete their reactions.

FIG. 3B depicts the absorption spectra of Chlorophyll A, Chlorophyll B, and Carotenoids aligned with the photosynthesis rate for the deep-blue and deep-red spectral bands of the LED luminaire of FIG. 1 exhibiting the regulated PPFD, according to embodiments of the present invention.

Chlorophyll A is the most important pigment in photosynthesis, while the other chlorophylls act as accessory pigments. Chlorophyll is responsible to absorb light, and transfer the light energy to biochemical reactions. In other words, chlorophyll is responsible for the plant development. The absorption peaks of Chlorophyll A are at 465 nm and 665 nm.

FIGS. 3A and 3B show that the spectral range of the light output of the LED luminaire of FIG. 1 is in good correspondence with the reference McCree action spectrum, as well as showing that the photosynthesis rate is maximized at the operational wavelengths. When operating in the vegetative mode (Vega), a spectral range of 650-670 nm wavelength light is needed, which is related to phytochrome Pr (as opposed to phytochrome Pfr).

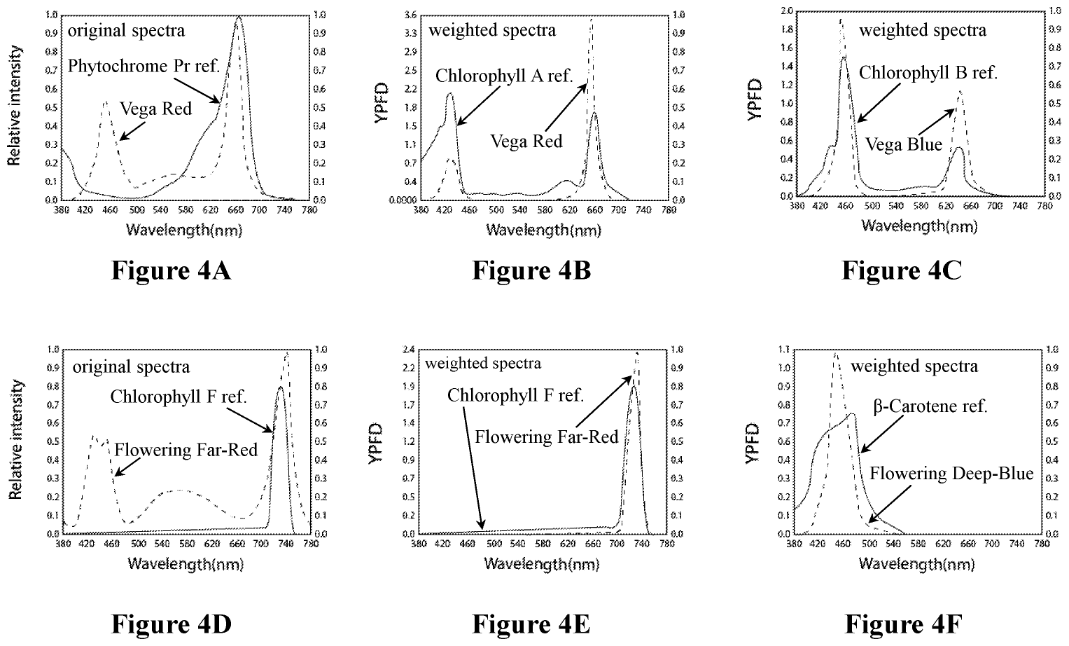

FIG. 4A depicts the original spectra of the Vega Red light output (vegetative mode) of the LED luminaire of FIG. 1 exhibiting the regulated PPFD and the reference Phytochrome Pr spectrum, according to embodiments of the present invention. As can be seen by the overlap of peaks, there is good spectral correspondence.

FIG. 4B depicts the weighted spectra of the Vega Red light output (vegetative mode) of the LED luminaire of FIG. 1 exhibiting the regulated PPFD and the reference Chlorophyll A spectrum, according to embodiments of the present invention. The axis label “YPFD” stands for Yield Photon Flux Density. FIG. 4C depicts the weighted spectra of the Vega Blue light output (vegetative mode) of the LED luminaire of FIG. 1 exhibiting the regulated PPFD and the reference Chlorophyll B spectrum, according to embodiments of the present invention. Absorption peaks appear at 720-750 nm for chlorophylls and at 380-540 nm for carotenoids.

FIG. 4D depicts the original spectra of the Flowering Far-Red light output (flowering mode) of the LED luminaire of FIG. 1 exhibiting the regulated PPFD and the reference Chlorophyll F spectrum, according to embodiments of the present invention. FIG. 4E depicts the weighted spectra of the Flowering Far-Red light output (flowering mode) of the LED luminaire of FIG. 1 exhibiting the regulated PPFD and the reference Chlorophyll F spectrum, according to embodiments of the present invention.

FIG. 4F depicts the weighted spectra of the Flowering Deep-Blue light output (flowering mode) of the LED luminaire of FIG. 1 exhibiting the regulated PPFD and the reference β-Carotene spectrum, according to embodiments of the present invention. Carotene pigments are responsible for developing the color in fruits and vegetables, with absorption peaks at 420 nm and 700+ nm.

A narrow band of select wavelengths correspond with certain absorption pigments. Namely, absorption peaks at 390-400 nm, 420 nm, 450 nm, 460 nm, 500 nm, 520 nm, 600 nm, 660-670 nm, 700-710 nm, and 730 nm. It is important to determine the intensity based on measurement of the PPFD of each peak in micromoles per square meter per second (μmol/m²s). Such peak intensities are shown below in Table 1.

Table 1 depicts the peak intensities of the light output of the LED luminaire of FIG. 1 exhibiting the regulated PPFD under operation at several input DC currents in vegetative mode (Vega Modules or VM) and flowering mode (Flowering Modules or FM), according to embodiments of the present invention.

TABLE 1
Peak intensities of the light output of the LED luminaire
of FIG. 1 exhibiting regulated PPFD under operation
in vegetative mode (VM) and flowering mode (FM).

| I | Vega Module (VM) | | Flowering Module (FM) | |
|---|---|---|---|---|
| (mA) | Blue VM 1 | Red VM 1 | Deep-Blue FM 2 | Far-Red FM 2 |
| off | 0 | 0 | 0 | 0 |
| 350 | 72 W (134 | 52 W (136 | 56 W (82 | 60 W (90 |
| | μmol/m²s) | μmol/m²s) | μmol/m²s) | μmol/m²s) |
| 500 | 104 W (180 | 78 W (190 | 82 W (126 | 90 W (126 |
| | μmol/m²s) | μmol/m²s) | μmol/m²s) | μmol/m²s) |
| 700 | 147 W (234 | 117 W (262 | 116 W (144 | 135 W (172 |
| | μmol/m²s) | μmol/m²s) | μmol/m²s) | μmol/m²s) |

The wavelengths associated with the designated Vega modules and the Flowering modules are as follows. The Vega modules include (a) Blue VM 1 with output absorption peaks at around 463 nm, 425 nm, and 410 nm; and (b) Red VM 1 with output absorption peak at around 656 nm. The Flowering modules include (a) Deep-Blue VM 2 with output absorption peaks at around 425 nm, 410 nm, and 390 nm; and (b) Far-Red VM 2 with output absorption peak at around 728 nm.

The “leader” peak for blue absorption-band diodes in the VM is at around 463 nm with a Full-Width at Half-Max (FWHM) of about 15 nm, based on relative intensity. The leader peak for red absorption-band diodes in the VM is at around 656 nm with an FWHM of about 10 nm, based on relative intensity. The leader peak for blue absorption-band diodes in the FM is at around 425 nm with an FWHM of about 15 nm, based on relative intensity. The leader peak for red absorption-band diodes in the FM is at around 728 nm with an FWHM of about 10 nm, based on relative intensity.

The LED luminaire system allows for smooth plant growth by changing the intensity of the PPFD—for example, by decreasing intensity above medium plant bushes, and increasing intensity at the edges of the plant beds in order to reach simultaneous plant ripening for all plant beds and to increase production.

Since the LED clusters are located a certain distance from each other, there is no excessive concentration of PPFD in the center, or insufficient PPFD near the edges of the exposure area, which is in sharp contrast to other commercial products. Even distribution of the PPFD favorably affects the development of fruit, both on the top and lower levels of the plants.

The LED luminaire control system allows for storing photosynthetic performance indicators, enabling the comparison of various system operating-mode conditions, which can be correlated to the quality of fruit on the plants and the harvested crop potential. System modifications allow for changing the slope angle of radiators 10 relative to the luminaire body by 35-45 degrees, depending on the bed geometry, in order to increase the rate of maturation and the uniformity of fruits growing in the middle and lower levels of the plant bushes.

The LED luminaire control system allows for the implementation of general-management integration of a greenhouse facility. The control system also allows for integration with systems analyzing the efficiency of the green-leaf photoperiod. Analysis systems can transfer information to the LED luminaire control system, which adjusts the output light spectra on the basis of photoperiod efficiency data. Such a configuration provides new opportunities for plant growth management by automatically selecting the most effective spectral bands for irradiation and exposure duration.

Unlike other systems, embodiments of the present invention provide red and blue diodes having far-red components and a UVA tail, which are key elements of the luminaire system. Furthermore, the diodes are collected in high density within a small area under a single lens. Thus, the spectrum does not contain separate, discrete, closely-packed diodes distributed over the surface area of the body, but rather the LED clusters form complex structures under unified lenses. This ensures spectrum uniformity, eliminating torn/sharp peaks, as well as ensuring spectrum uniformity and smoothness at any point in relation to the light source.

Due to the high intensity of a vegetative spectrum, a simulated sunny day can be shortened (i.e., it is possible to reduce the time of a vegetative photoperiod without damaging the plant). Since the complete selective-wavelength absorption spectrum of the luminaire system is produced under a single lens, the luminaire can be placed closer to the top leaves without fear of burning the leaves, which can result in turn in losses in spectral changes and efficiency. Such an arrangement provides a maximum spectral intensity.

The ratio of red and blue bands in the spectrum is optimized for a plant in a vegetative mode, which requires only 260 W out of a possible 510 W for a full absorption spectrum (i.e., energy is not expended to generate unnecessary wavelengths). In order to simulate a sunny day without causing stress to the plants (i.e., excluding unnecessary wavelengths), it is important that the red/blue ratio (e.g., 62:38) is maintained simultaneously through the independent control of each diode group.

As an example, the operating regimen of the luminaire system is provided for mimicking the daylight emission of a sunny day to illustrate the versatility and effectiveness of the luminaire system. Initially, the LED clusters are regulated to emit red spectral bands at low intensity in order to simulate early-morning daylight conditions. The intensity for the red spectral bands is then increased to an intermediate range, while the LED clusters are activated to also emit blue spectral bands at low intensity in order to simulate morning daylight conditions. The intensity for the blue spectral bands is then increased to an intermediate range in order to simulate pre-midday daylight conditions. The intensity for the red spectral bands is then increased to maximum intensity in order to simulate midday daylight conditions. (e.g., 12:00-12:30 pm). Finally, after a designated exposure duration, the intensity for the blue spectral bands is increased to maximum intensity in order to simulate late-afternoon daylight conditions (e.g., 1:00-3:00 pm).

A few hours of intensive exposure at maximum intensity completely provides a plant with its necessary energy. Exposure is then reduced gradually in reverse order to simulate daylight conditions representing the approach and onset of sunset. The blue bands are reduced to intermediate intensity, followed by reduction of the red bands to intermediate intensity. The blue bands are subsequently reduced to low intensity, then the red bands are reduced to low intensity. Finally, the blue bands are extinguished, and eventually the red bands as well, to simulate sunset. Maintaining a proper balance of red and blue light in the output spectrum is possible only with suitable system programming.

The switching or changing of spectral regions and intensity is performed without any pulsing. Thus, plants experience no stress from pulsating wavelengths (present in conventional lamps during traditional dimming procedures). Smooth switching and transitioning of photon energy creates a “soft” radiation exposure, which is more effectively absorbed by plant leaves than abrupt changes.

As another example to illustrate the versatility and effectiveness of the luminaire system, it may occur that plant bushes at the periphery of a multi-row garden bed are underdeveloped relative to the center portion of the bed rows due to intensity inhomogeneity. In such cases, it is possible to reduce the intensity at the center in order to restore growth homogeneity of the bushes throughout the entire garden bed over the course of a few days. As another example, if young bushes look distressed when working with their seedlings, exposure to isolated UV light via the Flowering Module (i.e., Blue FM 2) can be applied separately in order to strengthen their immunity and to achieve a therapeutic effect.

The ability of the luminaire system to enhance other plant attributes during growth, flowering, and maturation stages can also be performed by independently using isolated far-red spectral bands and blue bands having a UV tail. Depending on what kind of fruit properties are desired, the spectral wavelengths may be selected to boost such properties. For example, the presence of a soft-UV tail in the radiation exposure reduces the amount of overripe fruit located at higher heights on the plant, while increasing the ripening of fruit at lower heights on the plant, which significantly improves harvesting yield and quality. Exposure to isolated far-red bands and at high intensity is fundamentally important at these stages as well, corresponding to pigment absorption peaks, which are responsible for acquiring good fruit properties.

The modes of the luminaire system can be configured and activated directly via a standard wireless protocol (such as Wi-Fi) on a tablet, smartphone, or computer, as well as via a dedicated remote controller.

While the present invention has been described with respect to a limited number of embodiments, it will be appreciated that many variations, modifications, equivalent structural elements, combinations, sub-combinations, and other applications of the present invention may be made.

1. A luminaire for enhancing regulated plant growth in a vegetative mode, the luminaire comprising:
a) at least one vegetative Light-Emitting Diode (LED) cluster for providing enhanced regulated plant growth by simulating dynamic natural daylight conditions, wherein each said vegetative LED cluster has a cluster surface-area dimension of less than about 0.40 dm², and wherein said each vegetative LED cluster including:
i) a Blue Vegetative Module (VM) having a plurality of blue absorption-band diodes configured to produce a Photosynthetic Photon Flux Density (PPFD) of at least 150 micromoles per square meter per second (≥150 μmol/m²s); and
ii) a Red VM having a plurality of red absorption-band diodes configured to produce a PPFD of at least 200 micromoles per square meter per second (≥200 mol/m²s); and
b) at least one hemispherical lens for enabling even distribution of output spectral intensities and output spectral wavelengths from said Blue VM and said Red VM over a designated, target plant bed, each said hemispherical lens disposed to fully enclose said each vegetative LED cluster.

2. The luminaire of claim 1, wherein said cluster surface-area dimension is selected from the group consisting of: less than about 0.35 dm² and less than about 0.30 dm².

3. The luminaire of claim 1, wherein said each vegetative LED cluster is adapted to provide said output spectral intensities and output spectral wavelengths having a spectral intensity deviation and a spectral uniformity deviation of less than about 10% each, as determined by measurement differences between the center of said each vegetative LED cluster and an edge of said each vegetative LED cluster.

4. The luminaire of claim 3, wherein said spectral intensity deviation and said spectral uniformity deviation are less than about 5% each, as determined by measurement differences between the center of said each vegetative LED cluster and an edge of said each vegetative LED cluster.

5. The luminaire of claim 1, wherein said each vegetative LED cluster is adapted to provide said output spectral intensities having a total light power of at least about 130 W and a total light power density of at least about 325 W/dm².

6. The luminaire of claim 5, wherein said total light power density is selected from the group consisting of: at least about 370 W/dm² and at least about 430 W/dm².

7. The luminaire of claim 5, wherein said total light power is at least about 135 W and said total light power density is selected from the group consisting of: at least about 385 W/dm², at least about 450 W/dm², and at least about 500 W/dm².

8. The luminaire of claim 1, wherein said Blue VM has LED output characteristics exhibiting a leader peak at 463 nm with a Full-Width at Half-Max (FWHM) of 15 nm, based on relative intensity; and wherein said Red VM has LED output characteristics exhibiting a leader peak at 656 nm with an FWHM of 10 nm, based on relative intensity.

9. The luminaire of claim 1, the luminaire further comprising:
c) at least one power source for independently regulating said Blue VM and said Red VM using damped, direct current (DC) inputs in order to prevent PPFD outputs from flickering or pulsing during operational changes in said output spectral intensities and/or said output spectral wavelengths; and
d) at least one switching/control unit for independently programmably regulating, using said damped, DC inputs, said Blue VM and said Red VM in order to independently maintain a desired intensity ratio of said output spectral intensities and a desired wavelength ratio of said output spectral wavelengths between said Blue VM and said Red VM.

10. (canceled)

11. The luminaire of claim 1, the luminaire further comprising:
c) at least one radiator for enabling dissipating heat generated by said at least one vegetative LED cluster, wherein each said radiator is adapted to maintain low thermal resistance with a respective said vegetative LED cluster, and wherein said each radiator is adapted to maintain a radiator temperature below about 45° C. during operation of said respective vegetative LED cluster.

12. A luminaire for enhancing regulated plant growth in a flowering mode, the luminaire comprising:
a) at least one flowering Light-Emitting Diode (LED) cluster for providing enhanced regulated plant growth by simulating dynamic natural daylight conditions, wherein each said flowering LED cluster has a cluster surface-area dimension of less than about 0.40 dm², and wherein said each flowering LED cluster including:
i) a Deep-Blue Flowering Module (FM) having a plurality of blue absorption-band diodes configured to produce a Photosynthetic Photon Flux Density (PPFD) of at least 120 micromoles per square meter per second (≥120 μmol/m²s); and
ii) a Far-Red FM having a plurality of red absorption-band diodes configured to produce a PPFD of at least 150 micromoles per square meter per second (≥150 μmol/m²s); and
b) at least one hemispherical lens for enabling even distribution of output spectral intensities and output spectral wavelengths from said Deep-Blue FM and said Far-Red FM over a designated, target plant bed, each said hemispherical lens disposed to fully enclose said each flowering LED cluster.

13. The luminaire of claim 12, wherein said cluster surface-area dimension is selected from the group consisting of: less than about 0.35 dm² and less than about 0.30 dm².

14. The luminaire of claim 12, wherein said each flowering LED cluster is adapted to provide said output spectral intensities and output spectral wavelengths having a spectral intensity deviation and a spectral uniformity deviation of less than about 10% each, as determined by measurement differences between the center of said each flowering LED cluster and an edge of said each flowering LED cluster.

15. The luminaire of claim 14, wherein said spectral intensity deviation and said spectral uniformity deviation is less than about 5% each, as determined by measurement differences between the center of said each flowering LED cluster and an edge of said each flowering LED cluster.

16. The luminaire of claim 12, wherein said each flowering LED cluster is adapted to provide said output spectral intensities having a total light power of at least about 130 W and a total light power density of at least about 325 W/dm².

17. The luminaire of claim 16, wherein said total light power density is selected from the group consisting of: at least about 370 W/dm² and at least about 430 W/dm².

18. The luminaire of claim 16, wherein said total light power is at least about 135 W and said total light power density is selected from the group consisting of: at least about 385 W/dm², at least about 450 W/dm², and at least about 500 W/dm².

19. The luminaire of claim 12, wherein said Deep-Blue FM has LED output characteristics exhibiting a leader peak at 425 nm with a Full-Width at Half-Max (FWHM) of 15 nm, based on relative intensity; and wherein said Far-Red FM has LED output characteristics exhibiting a leader peak at 728 nm with an FWHM of 10 nm, based on relative intensity.

20. The luminaire of claim 12, the luminaire further comprising:
c) at least one power source for independently regulating said Deep-Blue FM and said Far-Red FM using damped, direct current (DC) inputs in order to prevent PPFD outputs from flickering or pulsing during operational changes in said output spectral intensities and/or said spectral wavelengths; and
d) at least one switching/control unit for independently programmably regulating, using said damped, DC inputs, said Deep-Blue FM and said Far-Red FM in order to independently maintain a desired intensity ratio of said output spectral intensities and a desired wavelength ratio of said output spectral wavelengths between said Deep-Blue FM and said Far-Red FM.

21. (canceled)

22. The luminaire of claim 12, the luminaire further comprising:
c) at least one radiator for enabling dissipating heat generated by said at least one flowering LED cluster, wherein each said radiator is adapted to maintain low thermal resistance with a respective said flowering LED cluster, and wherein said each radiator is adapted to maintain a radiator temperature below about 45° C. during operation of said respective flowering LED cluster.
